(19) United States
(12) Patent Application Publication
(10) Pub. No.: US 2003/0076351 A1
(43) Pub. Date: Apr. 24, 2003

(54) Method for display of contents

(76) Inventors: Toshikazu Ide, Tokyo (JP); Wataru Kageyama, Tokyo (JP)

Correspondence Address: Stephan A. Pendorf, Pendorf & Cutliff, P.O. Box 20445, Tampa, FL, 33622-0445, US

(21) Appl. No.: 10/061,558

(22) Filed: Feb. 1, 2002

(30) Foreign Application Priority Data
Oct. 23, 2001 (JP) 2001-325631

(51) Int. Cl. G09G 5/00

(52) U.S. Cl. 345/738

(57) ABSTRACT

There are provided technologies relating to a method for display of contents by which a screen saver function can easily be realized, using WEB browsers in a user terminal for display of a screen saver; even during access to other WEB sites, advertising display may be realized by automatic switching when there is no input to the user terminal in predetermined time; and screen savers, advertisements, and so on, which lead to increased opportunities for advertising display, are displayed.

As shown in FIG. 1, a schematic configuration for executing the method for display of contents according to the present embodiment comprises a WEB site 10 which supplies contents data 20DATA, such as moving pictures, for a screen saver (contents), and a user terminal 20 provided with a display device (display means) 20D for display of the screen saver, and display of the screen saver is controlled by a script language 20P executable on a browser in the side of the terminal 20.

### BACKGROUND OF THE INVENTION

1. Field of the Invention

The present invention relates to a method for display of contents, and, more particularly, belongs to technologies relating to a method for display of contents on a terminal through the Internet.

2. Description of the Related Art

Conventionally, parts of operating system functions, and pieces of unbundled application and so on have been used for a screen saver displayed on a user terminal. And, activation and termination of each window and link parts on screens have been used for screen transition, which includes advertising display, between WEB sites.

FIG. 7 is a view showing one display example of windows 120 in WEB sites according to a conventional technology.

FIG. 8 is a view showing one display example of other windows 130 displayed by a link part 120L in FIG. 7.

The window 120 has on the screen a link end part, or a link part 120L for windows to be displayed newly. In a similar manner to that of screen transition from the window 120 to other windows 130, screen transition between WEB sites by link is performed by click of the link part 120L with a mouse.

However, there have been the following problems in the conventional technology.

It has been required to install pieces of software and screen saver modules for one selves in order for a user to set favorable screen savers. Moreover, users in a beginner state have been able not easily to perform setting for downloading and installing pieces of software and data, as pieces of software and data with a maximum necessary storage area of several megabytes are required to be installed after downloading when screen saver modules are installed through the Internet.

Furthermore, there has been a problem that only advertising display relating to link parts on the own WEB sites can be performed in the case of advertising display by usual banners and so on using WEB browsers.

The present invention has been made considering the problems, and its object is to provide technologies relating to a method for display of contents by which a screen saver function can easily be realized without downloading and installing of pieces of software, using WEB browsers in user terminal for display of a screen saver; even during browsing of other WEB sites, advertising display can be realized by automatic switching when there is no input to the user terminal in predetermined time; and screen savers, advertisements, and so on, which lead to increased opportunities for advertising display, are displayed.

### SUMMARY OF THE INVENTION

The point of the present invention according to a first aspect lies in a method for display of contents using a network such as the Internet, which is characterized in that a WEB site for supplying contents comprises,

a first step to transmit a script language, which is operable on a browser at a terminal, for access from the terminal by a user, and

a second step to transmit contents data for display of contents based on control by the script language to the terminal; the first step includes

a third step for the script language on the browser to open a setting window through which function selection to decide whether a function for display of contents is put in an ON state, and setting of idle time for display of contents are performed, and for the script language on the browser to press the user for input of the function selection and the setting of idle time; and the second step includes

a fourth step for the script language on the browser to receive the contents data from the WEB site based on the function selection and the setting of idle time which have been input by the user, to open a different window on display means such as a display provided in the terminal, and to display the contents on the different window.

The point of the present invention according to a second aspect lies in a method for display of contents according to the first aspect, which is characterized in that

the third step includes a step to display a screen saver displayed in full-screen, in which external frames such as title bars and status areas are concealed, as the contents on the display means.

The point of the present invention according to a third aspect lies in a method for display of contents according to the first aspect, which is characterized in that

the third step includes a step to display advertisements, in which commodities information and public information are displayed, as the contents on the display means.

The point of the present invention according to a fourth aspect lies in a method for display of contents according to any one of aspects 1 through 3, which is characterized in that

the third step includes a step to display a test reproduction instruction part for the contents on the setting window, and to perform test display of the contents at once on selection of the test reproduction instruction part by the user.

The point of the present invention according to a fifth aspect lies in a method for display of contents according to any one of aspects 1 through 4, which is characterized in that

the fourth step includes a step to open the different window when there is no user action using a mouse or keyboards by the user after time equal to/over the time which has been set by the user at the setting of idle time.

The point of the present invention according to a sixth aspect lies in a method for display of contents according to any one of aspects 1 through 5, which is characterized in that

the fourth step includes a step to close the different window when there is user action using a mouse or keyboards by the user during opening the different window.

The point of the present invention according to a seventh aspect lies in a method for display of contents according to any one of aspects 1 through 5, which is characterized in that

the fourth step includes a step to display on the different window the contents with a link part for transition to a further different window, or for opening a new different window, and to perform transition to a further different window, or to open new different window when there is selection of the link part using a mouse or keyboard by the user.

The point of the present invention according to a eighth aspect lies in a method for display of contents according to any one of aspects 1 through 7, which is characterized in that

the fourth step includes a step to keep a state selecting whether the function for display of contents is put in an ON, or OFF state when the setting window is opened, and to put the function for display of contents in an OFF state when the setting window is closed.

The point of the present invention according to a ninth aspect lies in a computer program which can execute display of contents based on a method for display of contents according to any one of aspects 1 through 8, and is characterized in that

each step for a method for display of contents according to any one of aspects 1 through 8 is executed.

The point of the present invention according to a tenth aspect lies in a storage medium recording programs which can execute a method for display of contents according to any one of aspects 1 through 8.

### BRIEF DESCRIPTION OF THE DRAWINGS

FIG. 1 is a view showing one example of a configuration for realizing a method for display of contents according to the present embodiment;

FIG. 2 is a view showing one example of a window 20W displayed on the side of the terminal 20 in FIG. 1;

FIG. 3 is a view showing a setting window 20S which is opened by a setting link part 20L of the window 20W;

FIG. 4 is a view showing a different window 20W2 which is displayed on the terminal 20 in FIG. 1;

FIG. 5 is a view showing a schematic operation flow in FIG. 1;

FIG. 6 is a flow chart showing a flow of operations in the display of the screen saver setting window A which is shown in FIG. 5;

FIG. 7 is a view showing one display example of windows 120 in WEB sites according to a conventional technology;

FIG. 8 is a view showing one display example of other windows 130 displayed by a link part 120L in FIG. 7.

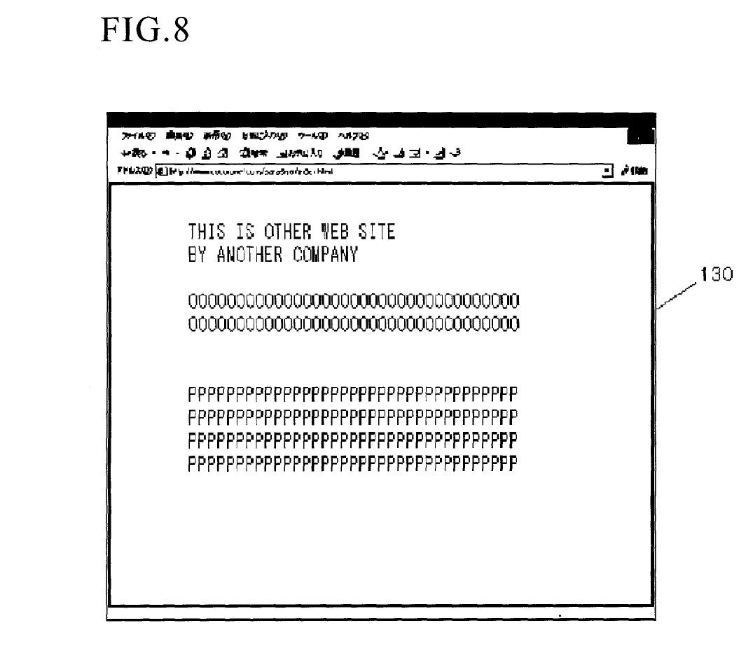

10: WEB site

20: terminal

20C: screen saver (contents)

20D: display device (display means)

20DATA: contents data

20L: setting link part

20P: script language

20S: screen saver setting window (contents-display setting window, setting window)

20T: function-selecting part

20U: idle time setting part

20W: window

20W2: screen saver window (different window, browser window)

20X: test reproduction instruction part

100: Internet

120: window

120L: advertising banners (link part)

130: advertising WEB sites (other window)

A: display of screen saver setting window

### DESCRIPTION OF THE PREFERRED EMBODIMENTS

Hereinafter, an embodiment according to the present invention will be described in detail, referring to drawings.

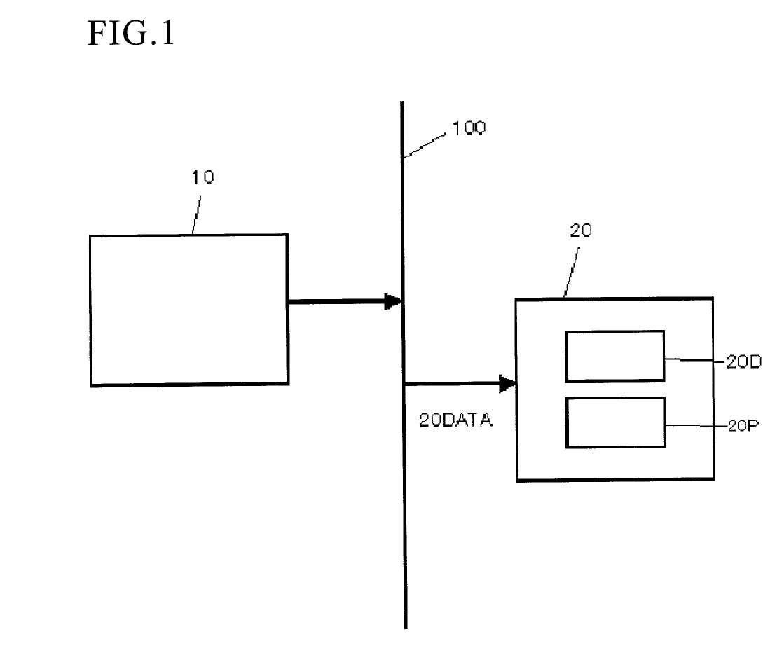

FIG. 1 is a view showing one example of a configuration for realizing a method for display of contents according to the present embodiment.

As shown in FIG. 1, a schematic configuration for executing the method for display of contents according to the present embodiment comprises a WEB site 10 which supplies contents data 20DATA, such as moving pictures, for a screen saver (contents) through a network such as the Internet 100, and a user terminal 20 provided with a display device (display means) 20D for display of the supplied screen saver, and display of the screen saver is controlled by a script language 20P executable on a browser in the side of the terminal 20.

The above contents data 20DATA are received in the browser of the side of the terminal 20, based on the function of the script language 20P transmitted from the WEB site 10 following access to the WEB site 10, and operations at the user terminal 20.

The screen saver (contents) is displayed on the display device 20D according to the contents data 20DATA transmitted from the WEB site 10, based on the control by the script language 20P under operation environments such as a virtual machine of the browser.

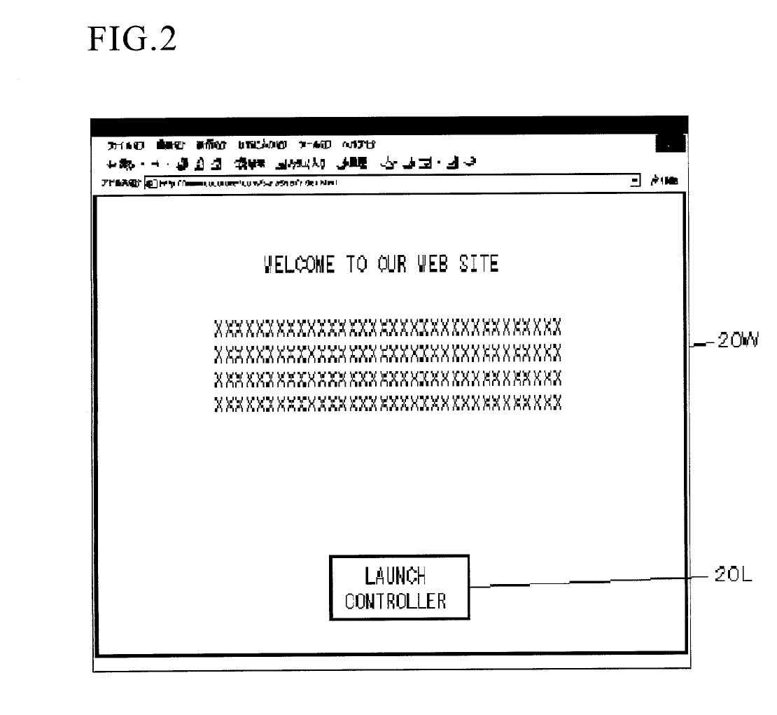

FIG. 2 is a view showing one example of a window 20W displayed on the side of the terminal 20 in FIG. 1 (client side)

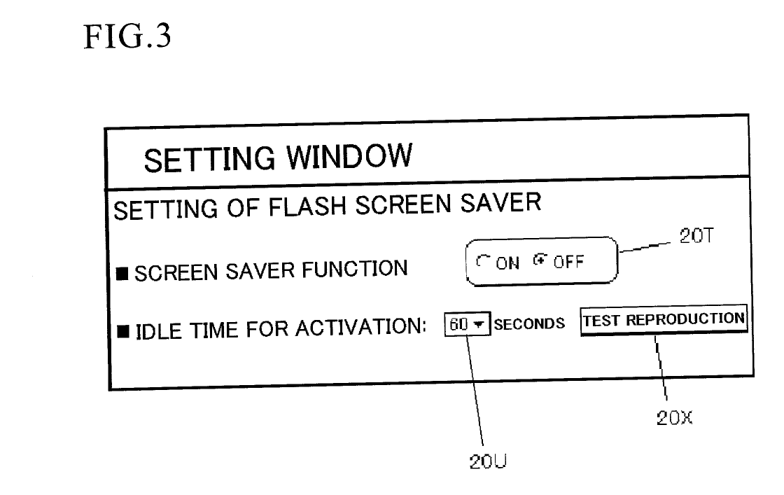

FIG. 3 is a view showing a setting window 20S in FIG. 2 which is opened by a setting link part 20L of the window 20W.

A screen of the window 20W supplied from the WEB site 10 is displayed on the display device 20D of the terminal 20 by access to the WEB site 10 through the Internet 100.

The window 20W comprises the setting link part 20L for opening a setting window 20S displayed as a different window.

Setting for display of the screen saver can be performed in the setting window 20S which is opened by operations of a user, such as clicking of a mouse which the terminal 20 comprises.

A function selecting part 20T for selecting ON or OFF of a screen saver function (a function for display of contents), an idle time setting part 20U for setting time required for activating and displaying the screen saver, and a test reproduction instruction part 20X for test display of the screen saver at once are displayed on the screen of the setting window 20S, as shown in FIG. 3.

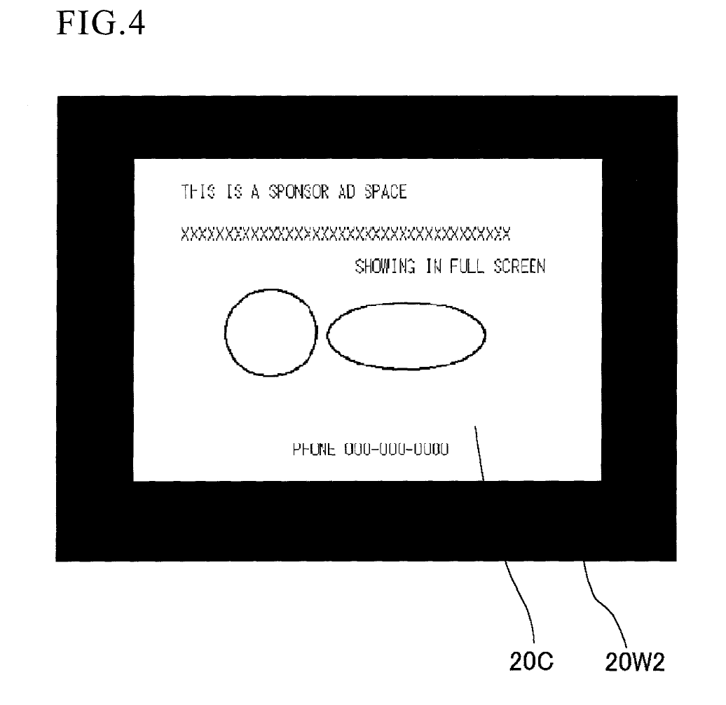

FIG. 4 is a view showing a different window 20W2 which is displayed on the terminal 20 in FIG. 1.

The screen saver 20C yielding the different window 20W2 is displayed with the function selecting part 20T, and the test reproduction instruction part 20X on the setting window 20S in FIG. 3.

Activating and displaying the different window 20W2 will be described in detail, referring to FIG. 1-FIG. 4.

When the screen saver function is put in an ON state after selecting “ON” on the function selecting part 20T in FIG. 3, programs in the script language 20P such as JAVASCRIPT and VBSCRIPT which have been previously set in the terminal 20 are executed, and monitoring of mouse action and keyboard action on the terminal 20 by the user is performed.

When the user performs neither mouse operations nor keyboard ones within time equal to/less than the time which has been set at the idle time setting part 20U, a different window on which the screen saver 20C is displayed is activated and displayed by the set program.

As the different window 20W2 is risen as the screen saver 20C in full-screen with concealed title bars and status areas, the user does not have a sense that a new window by the browser has been displayed, but have a sense that the screen saver 20C has been risen.

Moreover, activating and displaying by the test reproduction instruction part 20X, and a timer function in the idle time setting part 20U are also controlled by programs in the script language 20P.

The script language 20P has functions to perform the following control including calling of a time acquisition function for monitoring elapsing time.

A different window (browser window) 20W2 is displayed. In this case, processing for concealing of exterior frames such as title bars, and status areas, displayed by general browsers is performed for quasi-full-screen processing, and the different window is displayed so that the user does not have a sense that the different window is displayed by the browsers, but display is performed in a full-screen mode suitable for display of the screen saver 20C.

The screen saver (contents) 20C, which has been accumulated in a server providing the WEB site 10, is displayed on the browser window 20W2. In this case, display with a fixed URL, random display of the screen saver 20C from the side of the server providing the WEB site 10, and so on can be selected, based on selection by the user.

The browser window 20W2 is concealed, and the original screen display, which the user has been operating, is recalled, when there is mouse action or keyboard action on the terminal 20 during display of the browser window 20W2. Or, when the user clicks a linkpart (not shown) on the screen saver (contents) 20C displayed on the browser window 20W2, a new screen saver (contents) 20C corresponding to the link part is displayed by usual browser operations.

As the browser window 20W2 on which the screen saver 20 C is displayed is a WEB window on which title bars and so on are not displayed, browsing can be performed in a display scheme if a link part of the screen saver 20C is clicked by user action such as mouse action during display of the screen saver 20C. In this case, priority is given to the user action by interrupting the timer control using the time acquisition function.

Then, an operation flow of the method for display of contents will be described in detail.

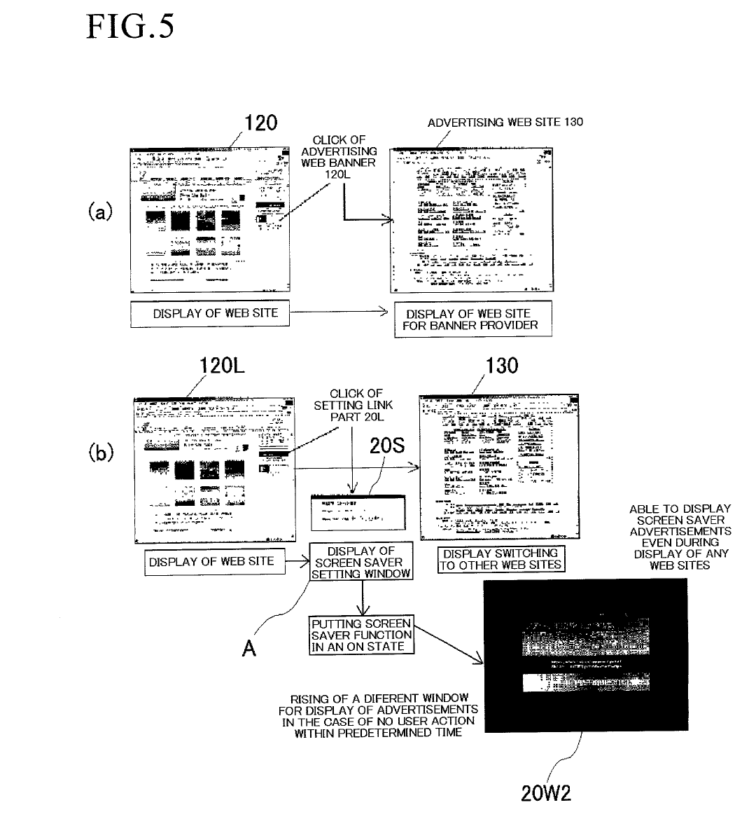

FIG. 5 is a view showing a schematic operation flow in FIG. 1.

In advertising display according to conventional technologies, advertising WEB sites 130 (other windows) are displayed by clicking advertising banners (link parts) 120L provided on the window 120(a).

On the other hand, in the method for display of contents according to the present embodiment, display of a screen saver setting window A is performed by clicking the setting link part 20L, though display of the other screens 130 is performed by clicking advertising banners 120L.

When there is no user action in predetermined time, a different window 20W2 is activated by putting the screen saver function in an ON state on the setting window 20S.

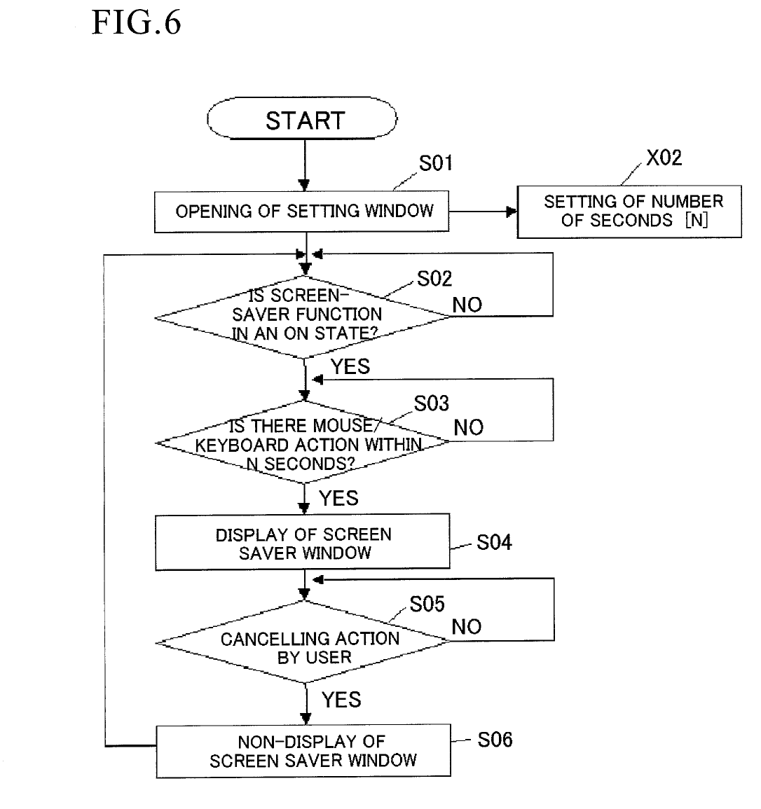

FIG. 6 is a flow chart showing a flow of operations in the display of the screen saver setting window A which is shown in FIG. 5.

The user operating the terminal can perform setting for putting the screen saver function in an ON or OFF state, and for determining time for activating the screen saver 20C on the screen saver setting window (contents-display setting window and setting window) 20S. Moreover, test display of the contents of the screen saver 20C can be performed at once by clicking the test reproduction part.

After the setting window 20S is opened (STEP S01) the user sets activation waiting time for activating the screen saver 20C (setting of number of seconds in the drawing) (STEP X02), using the setting window 20S. The above STEP X02 is performed at any time.

Subsequently, operations of the programs by the browser of the terminal 20 will be described.

It is judged whether the screen saver function is in an ON state or not (STEP S02).

When the screen saver function is in an ON state (YES in the drawing), it is judged (Is there mouse/keyboard action within N seconds ?, in the drawing) (STEP S03), by monitoring user's mouse action, or keyboard action with the use of the time acquisition function, whether the idle time which had been set by the idle time setting part 20U beforehand has elapsed.

When the idle time has elapsed (YES in the drawing) a different window 20W2 is opened, and the screen saver 20C is displayed (Display of the screen saver window in the drawing) (STEP S04).

It is judged by monitoring user's mouse action and keyboard action whether there has been canceling action by the user (STEP S05).

When there are user's mouse action or keyboard action (YES in the drawing), the different window 20W2 is closed, assuming that there has been canceling action by the user; the screen saver 20C is put in a non-display state (non-display of screen saver window in the drawing) (STEP S06); and the processing returns to STEP S02.

Operations at STEP S05 are repeated at predetermined timing, when there is no canceling action by the user at STEP S05 (NO in the drawing).

Operations at STEP S03 are repeated at predetermined timing, when the idle time has not elapsed at STEP S03 (NO in the drawing).

Operations at STEP S02 are repeated at predetermined timing, when the screen saver function is in an OFF state at STEP S02 (NO in the drawing).

The above operations are performed until the setting window 20S is closed by the browser of the terminal 20. Based on the operations, the window under operation which has been concealed behind the screen saver window 20W2 is displayed again when the user operates a mouse or keyboards during display of the screen saver 20C, as operations for which polling (loop) processing is performed in a script language such as JAVASCRIPT are activated by canceling action by the user, and the screen saver window (different window) 20W2 is closed. The user has a sense that the window under operation has been recovered from the screen saver 20C.

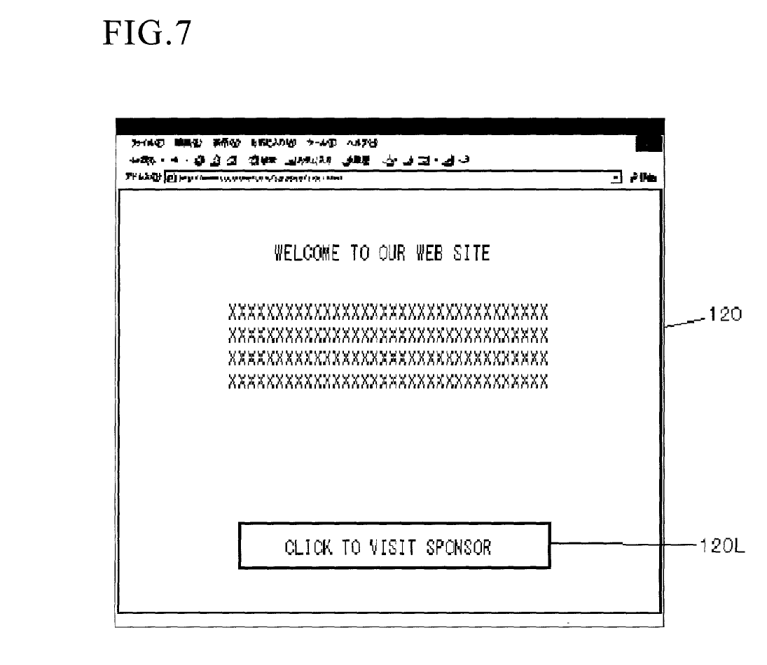

On the other hand, it is also possible, by providing a usual link part 120L in FIG. 7 so that other screen savers (contents) 20C may be displayed on the screen saver 20C, to set a configuration in which further other contents 20C may be displayed.

That is, it may be selected, depending on the characteristics of the contents 20C to be displayed, and the user's preferences, whether the priority is given to the screen saver function or to display of contents by clicking.

Moreover, it is also possible to set in detail for recovery of the original window what kind of user action is cancelled as user canceling action. The above setting may be performed in the script language, or even by description methods in the displayed contents.

As the method for display of contents according to the embodiment is configured as described above, the following advantage can be obtained.

Many kinds of screen savers 20C can easily be displayed without complex downloading and installing pieces of software by display of the screen saver 20C, using the WEB browsers in the terminal 20 with the screen saver setting window 20S.

Display of the screen saver 20C is effective during activating the setting window 20S, that is, until the setting window 20S is closed, and independent of the WEB site which the main window displays in the terminal processing by the user. As a result, advertising display by automatic switching becomes possible, and opportunities for advertising display which providers of the WEB sites 10 require can be obtained even by the browser in which advertising display related to banners in the own WEB sites is impossible in conventional technologies, when there is no input to the terminal 20 within predetermined time at display of other WEB pages.

Here, the contents data 20DATA which have been stored in a temporary storage area such as cookies may be used, though the terminal 20 receives the contents data 20DATA of the screen saver (contents) 20C from the WEB site 10 for each display of the screen savers 20C. Moreover, voice and moving picture information can easily be included in the contents 20C.

Furthermore, it is possible in a window 120 on a conventional WEB site to embed a function of the screen saver setting window 20S, and to put the screen savers (contents) 20C, which have been registered beforehand, in a display or non-display state for each user ID.

Moreover, the present invention is not limited to the embodiment, but the present invention may be applied to technologies related to methods for display of contents which are preferable for application of the present invention.

Furthermore, the numbers, the positions, forms and soon of the components are not limited to those of the embodiment, but may be made preferable for executing the present invention.

Here, like parts are designated by like reference numerals in each drawing.

As the present invention is configured as described above, the following advantages can be obtained.

A number of screen savers can easily be displayed on the WEB browsers in the user terminal without complex downloading and installing pieces of software by the use of the screen saver setting window.

Moreover, there is opportunities for display of advertisements even during display of contents by other WEB sites, as long as a screen saver setting window (controller) is displayed (under activating), as it is assumed that the contents are advertisement display. Furthermore, required terminal processing by the user is not prevented, as the advertisements are displayed when there is neither mouse action nor keyboard action by the user within predetermined time.

What is claimed is:

1. A method for display of contents using a network such as the Internet, characterized in that
a WEB site for supplying contents comprises,
a first step to transmit a script language, which is operable on a browser at a terminal, for access from said terminal by a user, and
a second step to transmit contents for display of contents based on control by said script language to said terminal; said first step includes
a third step for said script language on said browser to open a setting window through which function selection to decide whether a function for display of contents is put in an ON state, and setting of idle time for display of contents are performed, and for said script language on said browser to press said user for input of said function selection and said setting of idle time; and said second step includes
a fourth step for said script language on said browser to receive said contents data from said WEB site based on said function selection and said setting of idle time which have been input by said user, to open a different window on display means such as a display provided in said terminal, and to display said contents on said different window.

2. A method for display of contents according to claim 1, characterized in that
said third step includes a step to display a screen saver displayed in full-screen, in which external frames such as title bars and status areas are concealed, as said contents on said display means.

3. A method for display of contents according to claim 1, characterized in that
said third step includes a step to display advertisements, in which commodities information and public information are displayed, as said contents on said display means.

4. A method for display of contents according to any one of claims 1 through 3, characterized in that
said third step includes a step to display a test reproduction instruction part for said contents on said setting window, and to perform test display of said contents at once on selection of said test reproduction instruction part by said user.

5. A method for display of contents according to any one of claims 1 through 4, characterized in that
said fourth step includes a step to open said different window when there is no user action using a mouse or keyboards by said user after time equal to/over the time which has been set by said user at said setting of idle time.

6. A method for display of contents according to any one of claims 1 through 5, characterized in that
said fourth step includes a step to close said different window when there is user action using a mouse or keyboards by said user during opening said different window.

7. A method for display of contents according to any one of claims 1 through 5, characterized in that
said fourth step includes a step to display on said different window said contents with a link part for transition to a further different window, or for opening a new different window, and to perform transition to a further different window, or to open new different window when there is selection of said link part using a mouse or keyboard by said user.

8. A method for display of contents according to any one of claims 1 through 7, characterized in that
said fourth step includes a step to keep a state selecting whether said function for display of contents is put in an ON, or OFF state when said setting window is opened, and to put said function for display of contents in an OFF state when said setting window is closed.

9. A computer program which can execute display of contents based on a method for display of contents according to any one of claims 1 through 8, characterized in that
each step for a method for display of contents according to any one of claims 1 through 8 is executed.

10. A storage medium recording programs which can execute a method for display of contents according to any one of claims 1 through 8.
